(19) United States
(12) Patent Application Publication
(10) Pub. No.: US 2026/0299592 A1
(43) Pub. Date: Oct. 1, 2026

(54) SEMANTIC OBJECT DISAMBIGUATION AND ROBOT NAVIGATION USING A HIERARCHICAL SCENE GRAPH WITH SENSORIAL CONSTRAINTS

(71) Applicant: Mitsubishi Electric Research Laboratories, Inc., Cambridge, MA (US)

(72) Inventors: Moitreya Chatterjee, Boston, MA (US); Anoop Cherian, Boston, MA (US)

(73) Assignee: Mitsubishi Electric Research Laboratories, Inc., Cambridge, MA (US)

(21) Appl. No.: 19/094,830

(22) Filed: Mar. 29, 2025

(51) Int. Cl. G05D 1/246; G05D 101/15

(52) U.S. Cl. CPC G05D 1/2467; G05D 2101/15

(57) ABSTRACT

A robotic system is disclosed for performing object-related tasks in an environment using a semantic hierarchical scene graph constrained by the robot's perceptual capabilities. The system includes one or more sensors to provide a sensorial perception of the environment, a motor for navigation, memory storing a connected graph of nodes arranged hierarchically, and a processor configured to reason over the graph using a large language model (LLM). Nodes represent objects and semantic regions, and edges between nodes are created only when the robot can navigate between them without traversing unseen areas. The processor identifies a task-relevant subgraph using the LLM, based on the robot's current location and a received semantic instruction, and generates control commands to guide the robot accordingly. This enables object disambiguation and navigation based on spatial or functional context, even when visual attributes are insufficient, allowing robots to execute complex tasks in real-world, unstructured environments.

### TECHNICAL FIELD

This disclosure relates to the field of robotic perception and navigation, specifically to systems and methods that enable autonomous robots to locate, identify, and navigate to objects of interest in a natural 3D environment using a semantic hierarchical scene graph. The invention integrates sensor-based perception with artificial intelligence (AI)-driven reasoning, particularly leveraging Large Language Models (LLMs), to enhance object disambiguation beyond physical attributes, enabling robots to interpret and execute complex, context-aware navigation tasks. This technology finds applications in autonomous robotic assistance, warehouse automation, search and rescue, smart home robotics, and industrial robotics.

### BACKGROUND

Autonomous robotic systems are increasingly deployed in various environments, including homes, offices, industrial facilities, and disaster response scenarios. A fundamental capability required for such systems is object search and navigation, which enables robots to locate and retrieve specific objects in a complex, three-dimensional environment. This capability is critical for applications such as service robotics, warehouse automation, and assistive technologies, where robots must interact with their surroundings to accomplish tasks efficiently.

Traditionally, robotic object search and retrieval rely on predefined maps, object recognition algorithms, and sensor-based perception. Many current systems use computer vision techniques to identify objects based on their physical attributes, such as color, shape, size, and texture. Additionally, depth sensing and LiDAR-based mapping allow robots to build spatial representations of their surroundings and navigate toward target objects. These methods work well when objects are visually distinct and when the environment is structured with minimal occlusions or variations.

However, these conventional approaches face several limitations. Object recognition systems struggle when multiple instances of the same object class exist in an environment, especially when they share identical physical attributes. For example, an office setting may contain multiple coffee mugs of the same design, making it difficult for a robot to determine which one to retrieve based solely on vision-based classification. Similarly, an industrial robot navigating a warehouse may encounter multiple identical boxes, requiring additional information beyond visual cues to select the correct one.

To improve object search and navigation, researchers have explored various solutions. One approach involves tagging objects with RFID chips or QR codes, allowing robots to identify objects based on unique embedded identifiers. While effective in controlled environments, this solution requires prior labeling of objects, which is impractical for unstructured settings. Another approach involves deep learning models trained on large datasets of objects, enabling robots to improve recognition capabilities. However, such models are data-intensive and often struggle in novel environments where lighting, occlusions, or object placement differ from training conditions.

Other advancements in robotic navigation include SLAM (Simultaneous Localization and Mapping) algorithms, which allow robots to create real-time maps of their surroundings while navigating toward a goal. While SLAM improves spatial awareness, it does not inherently provide semantic understanding of objects or their contextual relationships. As a result, robots using SLAM may struggle with tasks requiring context-based disambiguation, such as distinguishing between similar-looking objects based on their placement or functional use.

Despite these advancements, current approaches remain limited in their ability to disambiguate objects based on higher-level contextual reasoning. Robots often lack the ability to interpret commands that refer to objects using semantic descriptors, spatial relationships, or functional context rather than physical attributes alone. For example, a user may instruct a robot to “fetch the laptop from John's desk,” but conventional systems cannot infer who John is or which desk belongs to them unless explicitly programmed with this information.

As robotic systems become more integrated into everyday life, there is a growing need for more advanced methods that allow robots to interpret object search tasks in a way that mirrors human reasoning. Improvements are needed in object identification, semantic reasoning, and adaptive navigation, allowing robots to make more informed, context-aware decisions rather than relying solely on predefined maps, visual markers, or static datasets.

### SUMMARY

The capability to search for objects of interest in a natural 3D environment is an important capability for effective embodied robotic agents and finds use in numerous scenarios including but not limited to: (i) searching for lost objects in a house, (ii) looking for trapped individuals in a disaster site, and (iii) picking up fallen objects, so as to ensure the floor/ground is navigable. When automated agents, such as robots, are tasked with such tasks, a common problem they encounter is having to disambiguate instances of the object they are looking for, in case more than one instance of such an object is present in an environment. For instance, such an agent could be looking for one particular laptop from all the ones that might exist in an office premises or for one particular coffee mug from all the ones that might be present in an apartment. While such disambiguation could be undertaken by describing the physical attributes of the object of interest, such as its shape or color, nonetheless identifying such an object by localizing it semantically might be of a much higher practical utility. Moreover, physical attribute based disambiguation might fail if all instances of the object share the said attribute. For example, all coffee mugs in an office might be of the same make, bearing the logo of the organization.

Consider, for instance, the task of looking for a laptop in a company's onsite premises. It might be more feasible to ask an agent to “look for a laptop in office number 10 in the north wing of the premises” rather than to ask it to “look for a gray laptop” or to “look for a laptop placed on a table” which may not be sufficiently discriminative. However, while robots can localize and/or identify objects using their sensorial ability enabling the robots to perceive and interpret information from their environment using sensors, such as vision, auditory, or touch sensors, robots lack reasoning going beyond the physical attributes of the objects. Even in such a simple example with the gray laptop, the robots may fail to identify the right “gray laptop” among multiple gray laptops. However, in practice, the search for objects of interest may necessitate even more complex reasoning, such as “go to the printer closest to the 5th office in the northeast block” or “bring me a book that my wife was reading yesterday.”

Conversely, complex AI models, such as Large Language Models (LLMs), exhibit various levels of reasoning abilities. While LLMs are not conscious or capable of genuine understanding, they can simulate the reasoning processes to a significant degree. Various aspects of LLM reasoning include logical, e.g., inductive and deductive reasoning, commonsense reasoning that allows LLMs to answer questions and make inferences based on general knowledge, causal reasoning, temporal reasoning that allows LLMs to reason about events in time, and spatial reasoning about spatial relationships and physical space.

Such reasoning capabilities can allow LLMs to disambiguate among different objects using semantic abstraction but come short of connecting the results of the reasoning with the robot's ability to perform the task. For example, even if the LLM can associate “a book that my wife was reading yesterday” with a red book on a table in a living room, the transformation of this reasoning into instructions to a robot located in a bedroom on the second floor, with the sensorial ability limited by the walls of the bedroom, is currently beyond LLMs capabilities.

To that end, it is an object of some embodiments to provide a system and a method that joins LLM reasoning with sensorial perception available to robots into a single solution enabling robots to search for objects of interest in response to receiving semantic commands, i.e., commands identifying objects beyond their physical attributes and potentially located outside of the reach of the sensors available to the robots.

The embodiments address this problem by constructing a connected hierarchical graph of the environment of interest that places object nodes associated with the objects into a multilevel hierarchy of semantic nodes having different semantic associations imposing different semantic meanings on their children nodes while connecting two semantic nodes with an edge only if the sensorial perception of a robot allows the robot to navigate from a space associated with one semantic node to a space associated with a connected semantic node, without going through a third semantic node. In such a manner, the edges of this graph are subject to sensorial constraints ensuring the navigation of the robot along the path formed by connected nodes.

Such a graph is referred to herein as a semantic hierarchical scene graph with sensorial connections of its nodes. The term “semantic” allows using the graph to reason about the scene, while sensorial connection ensures that a path of the graph can be used for robot navigation. By way of construction, a semantic hierarchical scene graph with sensorial connections of its nodes can connect LLM reasoning and the robot's sensorial ability to perform complex tasks.

Specifically, a connected hierarchical graph of nodes is a type of graph where nodes are organized in a hierarchy with a clear parent-child relationship between them, where every node is reachable from any other node. The hierarchical aspect of the graph ensures that nodes are arranged in levels or layers, with a single root node at the top level. Each node (except the root) has a parent node and can have multiple child nodes defining a partial order among the nodes. On the other hand, the connectivity aspect of the graph ensures that the graph is connected, meaning there is a path between any pair of nodes, and no part of the graph is isolated.

Some embodiments are based on recognizing that when the connected hierarchical graph of the environment is constructed subject to sensorial constraints on edges connecting the nodes, the resulting graph would grow to a higher level of abstraction to enable the connectivity prescribed by the connected graph, and that higher level of abstraction represented by semantic nodes is advantageous for both the semantic reasoning and robot navigation.

For example, objects in a kitchen such as cups, microwaves, and refrigerators can be connected with edges if visible to a robot located in the kitchen, but cannot be connected to a piano in a living room that is not visible to the robot while the robot is in the kitchen. Hence, to connect a cup in a kitchen with a piano in a living room, as required by the rules of the connected graph, there is a need to create semantic nodes such as a parent node “kitchen” having a cup as a child and a parent node “living room” having a piano as a child. If a spatial place associated with the semantic node “kitchen” is in sensorial proximity to the space associated with the semantic node “living room,” the nodes “kitchen” and “living room” can be connected with an edge, provided the agent does not need to traverse through a third semantic node to head from the “kitchen” to the “living room” or vice-versa. Otherwise, additional semantic nodes with a higher level of hierarchy need to be constructed, e.g., a parent semantic node “common area” associated with a place with sensorial proximity to both the kitchen and the living room. As seen from this example, in contrast with the object nodes, semantic nodes may not be associated with a specific object but can be associated with a specific location in the environment and a specific function of that location. In this example, a specific function can be the kitchen, and a specific location can be an entrance to the kitchen or a center of the kitchen.

As used herein, sensorial perseption, sensorial proximity, sensorial edges, and the like refer to the ability of the robot to navigate from one place to another using information acquired by the sensors of the robot. For example, a robot in the kitchen may be able to see all unobstructed objects in the kitchen and make its reasoning on how to disambiguate, navigate, and manipulate them. So, all these objects can be connected with edges or just be children of the same semantic node “kitchen” to indicate this ability. However, if an object is hidden in the cabinet in the kitchen, a robot may not be able to see it, so there is a need to create another semantic node “kitchen cabinet” that is a child of a “kitchen” node and has its object nodes as children. On the other hand, the robot may use internal and external sensors for its sensorial ability. If there is an external camera in the kitchen cabinet allowing the robot to make its own reasoning on how to locate an object in the cabinet of the kitchen, such additional semantic node can be optional.

In such a manner, the semantic hierarchical scene graph with sensorial connections of its nodes can be used by LLM to reason about the assigned task using abstraction captured by the semantic nodes and provide instructions to the robot using edges capturing abilities of the robots to navigate on its own. For example, once the hierarchical scene graph is constructed, the robot can localize its current location in the graph. For example, a robot can assign the object node that is closest to the robot in 3D space, as measured by the L2 distance between the centroid of the object point cloud and the robot's current location, denoted as the current location of the robot. The LLM is then tasked to predict the 2-hop subgraph along which the robot should traverse next, on its way to the target object. Because the hierarchical scene graph is constructed subject to a sensorial constraint on edges connecting the nodes, the requested navigation is possible for the robot.

Some embodiments are based on realizing the environment in which the robots may need to operate. While it is possible to initialize the semantic hierarchical scene graph using various rules of construction, some embodiments utilize an LLM to create and update the graph. Doing this in such a manner ensures that the semantic attributes of the semantic nodes correspond to the type of reasoning capabilities available to the LLM allowing the LLM to provide better guidance to the robot.

Accordingly, one embodiment discloses a robot for performing a task on objects in an environment, including: one or more sensors configured to provide a sensorial perception of the environment corresponding to current position of the robot; a motor configured to navigate the robot in response to control commands; a memory configured to store a semantic hierarchical scene graph representing the environment, the scene graph comprising a connected graph of nodes organized into a multilevel hierarchy, including nodes associated with objects in the environment, wherein edges between nodes are subject to sensorial connectivity constraints, such that an edge connects a first node to a second node only if the sensorial perception of the robot enables navigation from a location associated with the first node to a location associated with the second node without passing through a location associated with a third node; and a processor configured to iteratively identify a subgraph of the semantic hierarchical scene graph associated with the task within the semantic hierarchical scene graph using a large language model (LLM) trained with machine learning to exhibit reasoning abilities as applied to the task and the current position of the robot; and generate a control command for the motor of the robot based on the task and the portion of the semantic hierarchical scene graph.

Another embodiment discloses a method for performing a task on objects in an environment by a robot, wherein the method uses a processor coupled with stored instructions implementing the method, wherein the instructions, when executed by the processor carry out steps of the method, including: receiving a semantic instruction that includes spatial or functional context of the task; receiving, via one or more sensors, a sensorial perception of the environment corresponding to a current position of the robot; accessing a memory storing a semantic hierarchical scene graph representing the environment, the scene graph comprising a connected graph of nodes organized into a multilevel hierarchy including nodes associated with objects in the environment, wherein edges between nodes are subject to sensorial connectivity constraints such that an edge connects a first node to a second node only if the sensorial perception of the robot enables navigation from a location associated with the first node to a location associated with the second node without passing through a location associated with a third node; identifying a subgraph of the semantic hierarchical scene graph associated with the task using a large language model (LLM) trained with machine learning to exhibit reasoning abilities, the identification being based on the task and the current position of the robot within the scene graph; and generating a control command based on the identified subgraph and the task, and providing the control command to a motor to navigate the robot within the environment.

### BRIEF DESCRIPTION OF THE DRAWINGS

FIG. 1A illustrates a schematic representation of semantic object disambiguation and robot navigation using a large language model (LLM) and a semantic hierarchical scene graph, in accordance with some embodiments.

FIG. 1B illustrates a schematic of iterative robot navigation controlled by LLM reasoning over a perception-constrained subgraph of a semantic hierarchical scene graph, in accordance with some embodiments.

FIG. 2 illustrates an exemplary scene graph construction method that incorporates both semantic relationships and sensorial connectivity constraints, in accordance with some embodiments.

FIGS. 3A, 3B and 3C illustrate example scenarios demonstrating how semantic hierarchical scene graphs are constructed and used for disambiguation and navigation in various perceptual contexts, in accordance with some embodiments.

FIG. 4 illustrates cooperative object disambiguation by multiple robots, each with distinct sensor configurations and scene graph representations of the same environment, in accordance with some embodiments.

FIG. 5 illustrates an example robotic system architecture for performing semantic reasoning and sensor-based navigation using a hierarchical scene graph, in accordance with some embodiments.

FIG. 6 is a flowchart illustrating a method for performing a task using a robot that interprets semantic instructions and navigates using a perception-aware semantic hierarchical scene graph, in accordance with some embodiments.

FIG. 7 illustrates a schematic diagram of a navigation module comprising neural network components including a graph encoder, image encoder, and recurrent unit, used to generate control actions from scene graph subgraphs and sensor data, in accordance with some embodiments.

FIG. 8 illustrates a hierarchical scene graph including root, semantic, and object-level nodes with sensorial connectivity constraints, in accordance with some embodiments.

FIG. 9 illustrates a schematic of a robot navigating within a structured environment using semantic reasoning over a scene graph and sensory perception to complete a task, in accordance with some embodiments.

FIG. 10 illustrates a schematic diagram of a computing device architecture suitable for implementing various components of the robotic system, in accordance with some embodiments.

### DETAILED DESCRIPTION

A longstanding challenge in the field of autonomous robotics lies in enabling robots to reliably locate and navigate to specific objects in complex, real-world environments. This task is particularly difficult when multiple instances of the same object class are present—such as several laptops or coffee mugs-making it difficult to distinguish the correct object using only physical attributes like shape, color, or size. The problem is exacerbated in environments that are cluttered, or are partially observable. Traditional computer vision systems, although proficient in identifying objects based on visual features, often lack the ability to semantically disambiguate between similar instances or to interpret context-sensitive instructions such as “retrieve the laptop from John's desk.”

Some embodiments are based on recognizing that solving this problem requires a deeper integration of perception and reasoning. Large language models (LLMs), which are capable of advanced semantic reasoning based on natural language input and general world knowledge, are well-suited to interpret high-level commands and resolve ambiguities using contextual cues. However, LLMs lack direct access to the robot's physical state and cannot inherently account for the robot's sensor limitations or navigational constraints. Conversely, the robot may have detailed sensor data about its immediate surroundings but lacks the semantic understanding required to interpret abstract or relational commands. This disconnect between the robot's perception and the LLM's reasoning prevents either component from solving the problem independently.

To bridge this gap, the embodiments disclose a system architecture in which semantic reasoning and robotic perception are coupled through a novel data structure: a semantic hierarchical scene graph with sensorial connectivity constraints. This graph provides a multilevel representation of the environment, comprising nodes that represent both physical objects and higher-level semantic groupings (e.g., rooms, functional zones, or shared spaces). Crucially, the connections between nodes are constrained based on what the robot can perceive and physically navigate. Specifically, an edge is included between two nodes only if the robot's current sensor configuration and position allow it to navigate from the physical location associated with one node to the other without passing through an unseen or inaccessible third location.

In different implementations, the scene graph is constructed separately and/or the robot begins by constructing an initial version of the scene graph through a random walk, capturing egocentric RGB-D sensor data. The graph is updated over time using object detections. This is followed by spatial clustering and semantic label assignment with assistance from the LLM. Upon receiving a task—such as identifying or retrieving an object—the robot localizes itself within the graph, and the LLM is queried to determine the next portion of the graph to traverse. The LLM uses its reasoning capabilities, informed by the graph structure and the task prompt, to generate a subgraph containing nodes that guide the robot toward the target object. Because the graph is constructed with connectivity constraints tied to the robot's perceptual reach, the robot can independently execute navigation across the suggested subgraph.

This iterative navigation framework—where the robot repeatedly provides its updated perception and location to the LLM, and the LLM responds with an actionable subgraph—enables the system to disambiguate objects and execute complex, semantically rich commands. The robot's actions are continually grounded in its real-time sensory data, while the LLM ensures that its instructions remain semantically coherent and task-relevant. The result is a hybrid system that combines the abstract reasoning abilities of a language model with the grounded execution capabilities of a mobile robot, each compensating for the limitations of the other.

In effect, this approach enables robots to perform context-sensitive navigation and object retrieval tasks that go beyond traditional visual recognition. The framework is robust to changes in the environment and does not require exhaustive pre-programming of object locations or labels. From a commercial standpoint, the solution of this disclosure supports broad applications across industries such as warehouse automation, smart home systems, elder care, and search-and-rescue operations. It enables deployment of robots in unstructured environments with minimal manual setup, while providing a natural language interface that is accessible to non-technical users. In doing so, the disclosed solution improves autonomy, scalability, and usability-factors that are advantageous for widespread adoption of intelligent robotic systems.

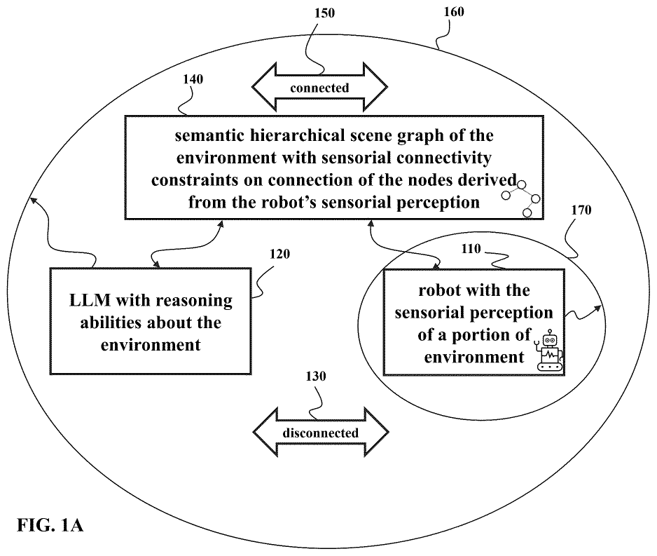

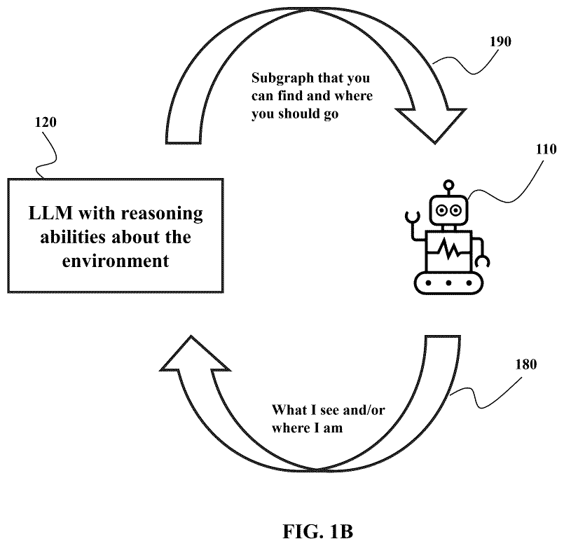

FIG. 1A illustrates a schematic representation of the principles underlying semantic object disambiguation and guided robot navigation in accordance with some embodiments. A robot 110 is deployed within an environment 160 and tasked with executing a command that references an object using semantic cues—such as spatial relationships or functional context-rather than merely physical descriptors. Successful completion of such tasks requires reasoning that goes beyond immediate visual perception.

However, robot 110 possesses only partial awareness of its surroundings, limited to a subset of the environment designated as 170, which falls within the scope of its current sensorial perception. This perception is inherently dependent on multiple factors, including the robot's current position and orientation, its physical structure, and the configuration, type, and resolution of its sensors. For example, the robot may be equipped with an RGB camera and a depth sensor mounted at a particular height or angle on its chassis. A robot with a higher-mounted sensor and greater sensor resolution may perceive a broader portion of the environment compared to a robot with low-resolution sensors positioned closer to the ground. Accordingly, the observed portion of the environment 170 varies dynamically and may exclude critical context needed to understand and execute the assigned task.

To compensate for the robot's limited field of perception and to enhance task comprehension, some embodiments employ a large language model (LLM) 120. The LLM is capable of performing high-level semantic reasoning across the broader environment 160, including making inferences about spatial layout, object relationships, or task-related functional areas. However, this reasoning is often disconnected (130) from the practical capabilities of the robot 110, because the LLM lacks awareness of the robot's real-time perceptual boundaries and actuation constraints. As a result, although the LLM may generate plausible reasoning paths or instructions, those may not be directly executable by the robot given its localized, constrained perception.

To bridge this reasoning-perception gap, some embodiments generate a semantic hierarchical scene graph 140. This graph serves as a structured, multilevel representation of the environment 160, constructed with explicit awareness of the robot's sensor-derived perception. The scene graph includes nodes corresponding to objects in the environment, as well as semantic groupings such as rooms, functional spaces, or contextual zones. The graph is hierarchically organized and incorporates sensorial connectivity constraints: that is, an edge between two nodes is included only if the robot 110 is capable of navigating from the physical location associated with the first node to that of the second node without passing through a location outside of its perceptual scope. This ensures that any path derived from the graph reflects both semantic understanding and physical navigability from the robot's perspective.

The semantic hierarchical scene graph 140, when constructed in accordance with these constraints, enables a coupling 150 between the robot's perceptual capabilities and the LLM's semantic reasoning. This coupling provides a shared, grounded representation of the environment that allows the LLM 120 to generate task-specific guidance that respects the robot's limitations. In operation, this framework supports iterative navigation and semantic disambiguation: the LLM identifies an appropriate next subgraph or navigation target based on the task, while the robot interprets and executes those instructions within its own perceptual and motor capabilities. Thus, the system enables robots to perform complex, semantically contextualized tasks that would otherwise be infeasible with perception or reasoning alone.

FIG. 1B shows a schematic diagram illustrating an iterative robot navigation process guided by the reasoning capabilities of a large language model (LLM) 120, in accordance with some embodiments. The navigation process is supported by a semantic hierarchical scene graph 140 that represents the environment and includes nodes connected according to sensorial connectivity constraints. These constraints ensure that two nodes in the graph are connected by an edge only if the robot 110 is capable of navigating between the corresponding physical locations without passing through areas outside its perceptual range. This structure enables safe and feasible path planning from the perspective of the robot's onboard sensors.

Upon receiving a task—such as retrieving an object or navigating to a functionally defined location—the LLM 120 performs semantic reasoning to determine a sequence of intermediate steps required for successful task execution. The reasoning process accounts for the current position and/or real-time sensor measurements 180 from the robot 110, which describe the robot's present location and the portion of the environment currently visible or otherwise detectable by its sensors.

Based on this information, the LLM 120 selects a subgraph 190 of the overall semantic hierarchical scene graph 140. This subgraph represents a localized, navigable segment of the environment that leads the robot toward the ultimate task objective. Each node in the subgraph corresponds to an object or region that lies within a sensorially reachable path from the robot's current position. The structure of the subgraph ensures that traversal along its edges is physically realizable by the robot, given the robot's sensor configuration and environmental constraints.

In this manner, the LLM iteratively controls the robot to navigate toward completing the task. Upon receiving updated location information and/or sensor measurements 180, the LLM retrieves the next portion 190 of the scene graph 140, guiding the robot incrementally closer to successful task completion.

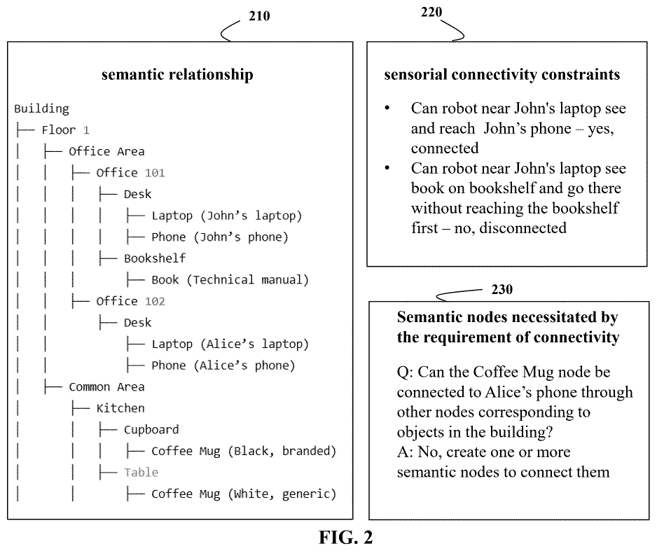

FIG. 2 shows an exemplary illustration of the principle of constructing a semantic hierarchical scene graph in accordance with some embodiments. In this representation, nodes are created to represent individual objects in the environment, and edges between the nodes reflect not only semantic relationships between objects 210—such as co-location, functional association, or categorical similarity-but also sensorial connectivity constraints 220. These constraints are defined such that an edge is included between two object nodes only if the robot 110, using its onboard sensors and current configuration, is capable of navigating from the physical location associated with one object to the location of the other, without requiring perception or traversal through intermediate regions beyond its sensory reach.

In other words, the presence of an edge in the graph implies that the robot 110 can perceive and reach the connected object directly, given its current sensory capabilities and spatial constraints of the environment. This approach ensures that the graph does not merely reflect semantic reasoning but also encodes physically realizable paths in the environment as constrained by the robot's perception.

Furthermore, to ensure that the resulting scene graph is fully connected—i.e., there are no isolated nodes or unreachable components—the graph must incorporate an additional layer of abstraction. In practical and realistic environments, not all objects are directly visible or reachable from one another. Therefore, some embodiments introduce semantic hierarchy nodes 230 that cluster together related object nodes based on their spatial or functional semantics. These semantic nodes serve as intermediate layers in the graph structure, enabling higher-level grouping and connectivity between otherwise disconnected object nodes.

For example, a robot may be able to perceive a coffee mug on a table and a microwave on a kitchen counter, when it itself is in the kitchen, but not a plate in the living room. To connect all these objects in a semantically and perceptually meaningful way, the graph may include parent nodes labeled “kitchen” and “living room” that groups the corresponding objects. If two such semantic nodes (e.g., “kitchen” and “living room”) are within the robot's navigable space based on its perception and motion capabilities, they can be connected by an edge at a higher level in the hierarchy. Thus, the scene graph grows in semantic depth as required to preserve connectivity, ensuring that the robot can reason over and navigate the entire environment, even when direct object-to-object connections are not available.

This hierarchical and perception-aware graph structure enables both semantic disambiguation and feasible navigation, allowing a large language model (LLM) to reason over abstract regions while ensuring that any proposed path is physically realizable by the robot. The inclusion of multilevel semantic nodes provides scalability and robustness, especially in cluttered or partially observable environments where direct connections are limited or infeasible.

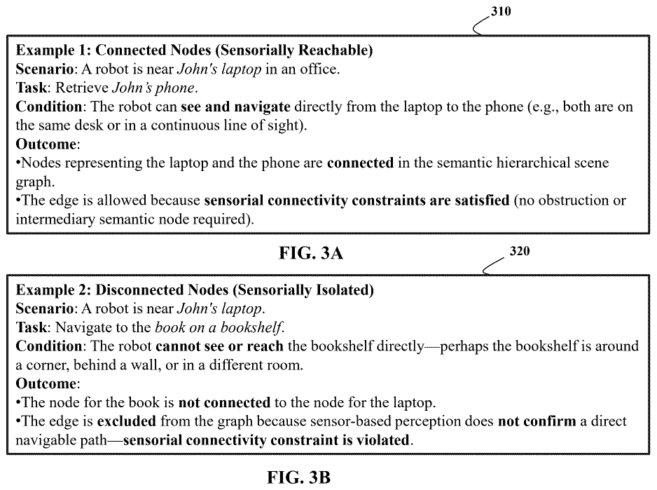

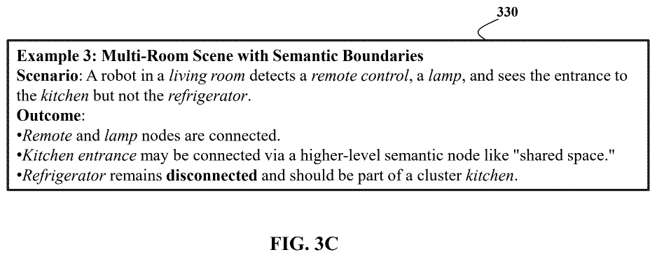

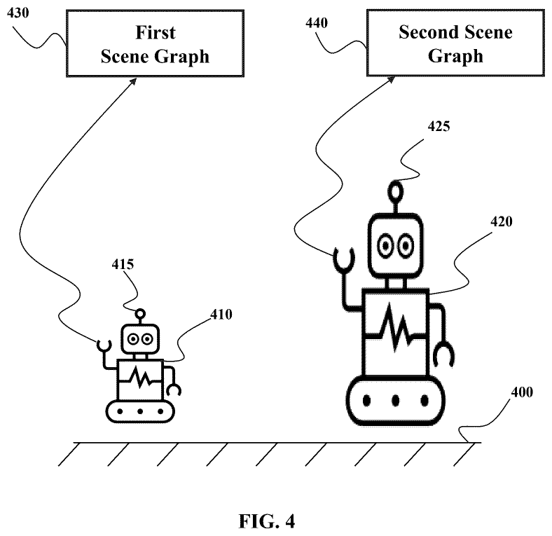

FIGS. 3A, 3B, and 3C show illustrative examples demonstrating the principles of constructing a semantic hierarchical scene graph with sensorial connectivity constraints, in accordance with some embodiments. These examples help clarify how the structure of the graph is derived from both semantic relationships and the perceptual capabilities of the robot within different real-world scenarios.

In an example 310 of FIG. 3A, a robot is located near John's laptop in an office environment and is given the task of navigating to John's phone. In this example, the robot can directly perceive and reach both the laptop and the phone, as they may be on the same desk or within an unobstructed line of sight. As a result, the nodes representing the laptop and the phone are connected in the scene graph because the sensorial connectivity constraint is satisfied—there is a direct navigable path between them based on the robot's perception. This is an example of connected object nodes due to spatial and sensory proximity.

An example 320 of FIG. 3B illustrates a contrasting scenario where the robot is again near John's laptop, but this time the task is to navigate to a book on a bookshelf. However, the robot cannot directly see or reach the bookshelf—perhaps due to occlusions, walls, or being in a different room. In this case, there is no edge between the node representing the laptop and the node representing the book. The sensorial connectivity constraint is violated, and therefore the objects remain disconnected in the graph. This highlights how the scene graph captures not just semantic intent but perceptual feasibility.

An example 330 of FIG. 3C shows a multi-room scenario that emphasizes semantic grouping at higher abstraction levels. A robot is situated in a living room where it can detect a remote control and a lamp, both of which are within its perceptual range and therefore connected in the scene graph. The robot also sees the entrance to a kitchen but cannot perceive the refrigerator, which is located deeper within the kitchen and outside the robot's current sensory range. In this case, the refrigerator node remains disconnected, but the graph may include a semantic node representing the kitchen, which groups the refrigerator and other kitchen-related objects. The kitchen entrance may be connected to the living room via a shared semantic region such as a hallway or open space. This example illustrates the use of semantic nodes to maintain graph connectivity even when some objects are not directly visible, enabling abstract reasoning and gradual navigation across rooms.

Taken together, FIGS. 3A-3D highlight how the scene graph structure dynamically adapts to the robot's real-time sensory context, using a combination of object nodes, semantic grouping, and sensorial connectivity constraints to guide effective reasoning and navigation in complex, real-world environments.

FIG. 4 illustrates a schematic representation of cooperative object disambiguation performed by multiple robots, each constructing a distinct semantic hierarchical scene graph for the same environment, in accordance with some embodiments. This example highlights how differences in sensor configurations between robots can result in different perceptual representations of the same physical space.

In some embodiments, the task is carried out by a first robot 410, which is equipped with a first set of sensors 415, in cooperation with a second robot 420, which has a second, different set of sensors 425. The sensors used by each robot may vary in type, resolution, field of view, or mounting height, depending on the physical dimensions of the robots or their intended functional roles. For instance, the second robot 420 may have sensors 425 mounted higher above the ground 400 than the sensors 415 of the first robot 410. This difference could arise due to variations in robot body design, the placement of the sensors on the chassis, or differences in sensor hardware (e.g., a wide-angle camera versus a narrow-field RGB-D sensor).

As a result of these differences in sensor configuration and perceptual reach, the two robots may generate distinct semantic hierarchical scene graphs for the same shared environment. For example, robot 410 may construct a first scene graph 430 based on the portion of the environment it can perceive and interpret, while robot 420, using its own sensors and vantage point, may construct a second scene graph 440 that differs in structure, node connectivity, or semantic grouping. These differences may include visibility of occluded areas, detection of elevated objects, or differing levels of semantic abstraction due to sensor range or resolution.

Despite representing the same physical space, these scene graphs may differ in the number of nodes, the hierarchical grouping of those nodes, and the edges defined by sensorial connectivity constraints. Nevertheless, by exchanging information—such as scene graph substructures, object observations, or semantic labels—the robots can collaboratively resolve ambiguities in object identity and location. For instance, one robot may detect a target object that the other cannot, enabling cooperative navigation or task execution that neither could achieve independently.

Such multi-agent embodiments enhance robustness and adaptability in real-world environments, allowing robots with complementary capabilities to work together to perform tasks involving complex object disambiguation or distributed search. The system accommodates heterogeneity in perception while maintaining a coherent shared understanding of the environment through structured graph representations.

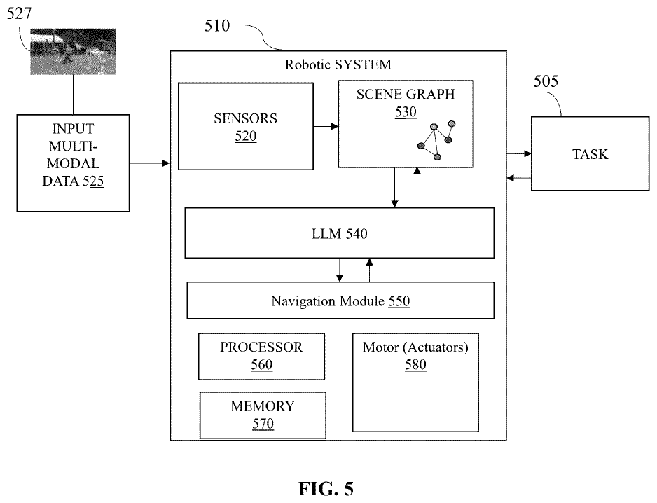

FIG. 5 illustrates an example robotic system architecture 510 for performing tasks within an environment using semantic reasoning and sensor-based perception, in accordance with some embodiments. The system may be implemented in various ways, but generally includes components for sensing, reasoning, memory, and control.

The robot includes sensors 520 that provide sensorial perception of the environment. These sensors may include cameras, LiDAR, or other types of sensing modalities capable of capturing spatial and object-level information corresponding to the robot's current position. The sensors 520 can be a single or—multimodal sensors to collect single 527 or multi-modal 525 data. For example, the multi-modal data 525 collected by these sensors reflects the portion of the environment that is presently observable by the robot and forms the foundation for navigation and decision-making.

The system receives a task 505, which may be a semantic instruction that references objects, spatial relationships, or functional goals—for example, “bring the coffee mug from the kitchen.” This instruction may be user-defined or generated autonomously by a higher-level controller.

To support spatial and semantic reasoning, the robot maintains a representation of its environment in the form of a semantic hierarchical scene graph 530. This graph is typically stored in memory 570 and includes nodes representing objects or locations, organized into a hierarchy. The edges connecting these nodes are subject to sensorial connectivity constraints. That is, an edge is present between two nodes only if the robot, based on its current or past sensorial perception, can reasonably navigate between the corresponding locations without passing through an unobservable or obstructed area.

The system also includes a language model 540 trained to reason over tasks and scene representations. In one embodiment, this large language model is stored in memory 570 and accessed locally by the robot. In another embodiment, the language model may be located on a remote computing system, such as a cloud-based server, and accessed via a network connection. The model is used by processor 560 to identify a task-relevant subgraph within the scene graph 530. This subgraph may highlight a path, set of objects, or region in the environment that is necessary for completing the current task.

Once the subgraph is identified, the processor 560 generates a control command based on both the task and the identified subgraph. In some implementations, the processor 560 execute a navigation module 550 to determine the command. In addition, the navigation module 550 or other controller (not shown) may be configured to interpret the command and issue low-level control instructions to the robot's motor or actuators 580. These instructions guide the robot's physical movement through the environment to carry out the assigned task. For example, the low leel instructions may include the actions of the robot such as moving forward, turning left, turning right, looking up, looking down, and stopping.

The scene graph, sensor data, and LLM-generated reasoning are used in combination to ensure that the robot's actions are grounded in its current perception of the environment. This integration supports responsive and context-aware behavior, even in settings where parts of the environment may be occluded.

It should be understood that variations in system design are possible. For example, different implementations may use different types of scene graphs, reasoning models, or communication methods between components. The architecture shown in FIG. 5 represents one possible configuration consistent with the described approach.

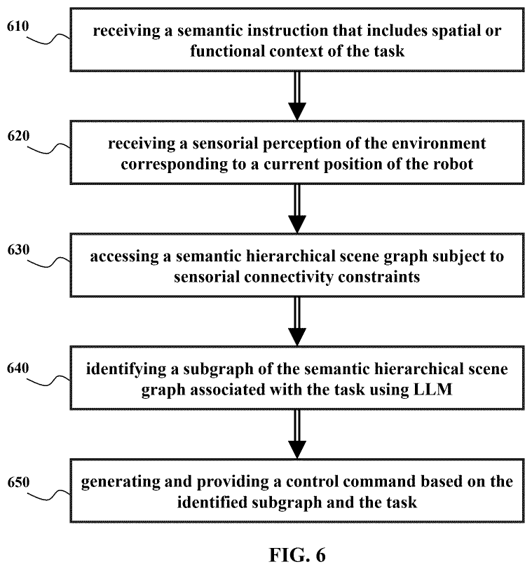

FIG. 6 illustrates a flowchart of a method for performing a task on one or more objects in an environment using a robot, in accordance with some embodiments. The method may be implemented by a processor coupled with memory storing instructions, which when executed, cause the robot to interpret semantic commands and navigate its environment using a perception-aware hierarchical scene graph.

At block 610, the method begins by receiving a semantic instruction that includes spatial or functional context for the task. The instruction may originate from a user input, a higher-level agent, or another system component, and may include references to object types, locations, ownership, or activities (e.g., “bring me the laptop from John's desk”).

At block 620, the robot receives a sensorial perception of the environment. This perception is derived from one or more onboard sensors (e.g., RGB cameras, depth sensors, LiDAR) and corresponds to the robot's current position and field of view. The sensor data captures the portion of the environment that is visible or otherwise accessible based on the robot's physical configuration and orientation.

At block 630, the method includes accessing a semantic hierarchical scene graph stored in memory. The scene graph represents the environment as a connected graph of nodes organized into a multilevel hierarchy. Nodes may correspond to detected objects, functional zones (e.g., kitchen, hallway), or higher-level semantic regions. Importantly, edges between nodes are subject to sensorial connectivity constraints, meaning an edge exists between two nodes only if the robot is capable of navigating from the location associated with one node to the location associated with the other without traversing an unseen or unreachable intermediate space.

At block 640, the method further comprises identifying a subgraph of the semantic hierarchical scene graph that is relevant to the task. This subgraph is identified using a large language model (LLM) trained with machine learning to exhibit reasoning capabilities. The LLM is provided with the current robot position and the task instruction, and in response, generates a subgraph comprising nodes and edges forming a valid navigable path toward the target object or region, consistent with the robot's perceptual constraints.

At block 650, the system generates a control command based on the identified subgraph and the task. This control command may include navigation instructions such as direction, orientation, or motor actuation signals, which are then provided to the robot's motion system to begin movement through the environment. The robot further executes the control command, updating its position and perception.

In some embodiments, this process is iterative, where the updated robot state is returned to the LLM for further subgraph generation and guidance, thereby enabling stepwise progression toward the goal object while adapting to new perceptual inputs.

This method allows for semantic disambiguation and task execution based on a combination of symbolic reasoning and grounded perception, enabling robots to interpret complex commands and operate effectively in unstructured, real-world environments.

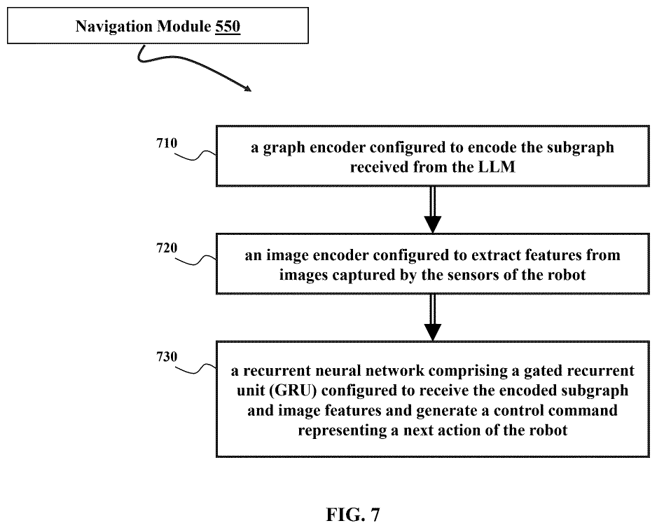

FIG. 7 illustrates a schematic diagram of a navigation module 550 configured to generate robot control commands based on a combination of semantic reasoning outputs and sensor-derived perceptual data, in accordance with some embodiments. The navigation module is responsible for converting a high-level semantic plan, such as a subgraph identified by a large language model (LLM), into executable motor commands for guiding a robot through a physical environment.

The navigation module comprises a graph encoder 710, which is configured to process a subgraph received from the LLM. The subgraph is a portion of a semantic hierarchical scene graph and includes nodes and edges representing navigable paths and semantically relevant locations or objects. The graph encoder encodes the subgraph using a sequence of graph convolutional layers, which may include graph attention layers and edge convolution layers. These layers extract structural and semantic features from the graph, allowing the navigation system to reason about object relationships, spatial layout, and path feasibility.

In parallel, the navigation module also includes an image encoder 720 configured to extract features from visual sensor data captured by the robot. The input to the image encoder may include RGB images, depth maps, or other multimodal sensor inputs. The image encoder applies deep learning-based feature extraction—e.g., convolutional neural networks (CNNs) such as ResNet or other backbones—to produce a compact feature representation of the robot's current visual field. This enables the system to align perceived environmental features with the abstract subgraph representation received from the LLM.

The outputs of the graph encoder and image encoder are then fused and provided to a recurrent neural network (RNN) 730, which includes a gated recurrent unit (GRU). The GRU is configured to process this combined feature set over time, maintaining a memory of prior states and navigation context. Based on the fused data, the GRU generates a control command representing the robot's next action, such as moving forward, turning left, turning right, or stopping. This command is then passed to the robot's motor or actuation system to execute the corresponding movement.

In some embodiments, the navigation module is continuously updated as the robot receives new perceptual data and subgraph predictions. This architecture enables the robot to adapt its trajectory in real time and follow complex, semantically-driven instructions while remaining grounded in its sensorimotor capabilities.

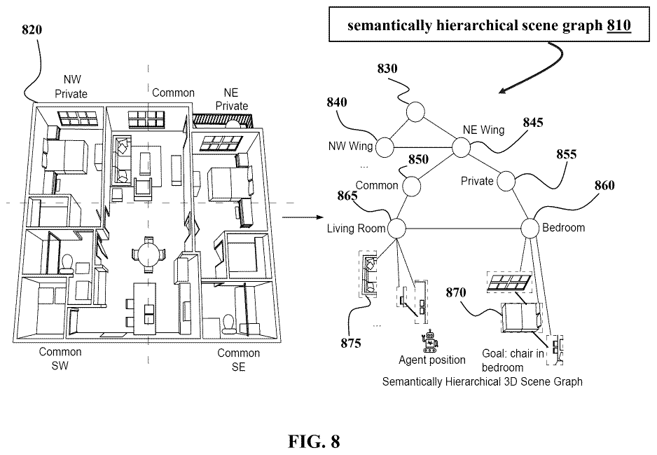

FIG. 8 illustrates a semantic hierarchical scene graph 810 representing an environment 820 in which a robot operates, in accordance with some embodiments. This figure demonstrates how the environment is structured into multiple layers of semantic abstraction, enabling the robot to perform context-aware navigation and object disambiguation tasks.

In one embodiment, the scene graph 810 includes a root node 830 that represents a global region of the environment 820. This root node provides the highest level of abstraction and may correspond to an entire home, office building, factory floor, or another well-defined physical domain.

In some embodiments, the graph includes a plurality of intermediate semantic nodes, such as nodes 840, 845, 850, 855, and 860 which represent functional areas within the global region. These may include specific rooms (e.g., kitchen, living room, office), zones (e.g., desk area, hallway), or other spatial groupings based on usage or physical boundaries. These intermediate nodes function as organizational structures that group object nodes under shared contextual or spatial meaning.

Beneath each semantic node, the graph includes a set of leaf nodes, such as 870, and 875, which represent individual objects detected within those semantic areas. For example, the node 870 may correspond to a bed located in the bedroom 860, while node 875 may correspond to a coach in the living room 865. Each object node is associated with its semantic parent, capturing the functional or spatial context of the object.

In some embodiments, each node in the graph is associated with one or more attributes, which may include: a semantic label (e.g., “lamp,” “microwave”), a spatial location (e.g., 3D coordinates, point cloud centroid), a hierarchical level (e.g., root, semantic zone, object), and a set of neighboring nodes. The neighboring nodes are connected via edges that satisfy sensorial connectivity constraints, meaning the robot is capable of physically navigating between the locations represented by the connected nodes using its onboard sensors.

In one embodiment, the semantic hierarchical scene graph is constructed as a tree-like structure, in which each non-root node has a single parent node corresponding to a higher-level semantic region. For instance, an object node (e.g., a coffee mug) would be the child of a semantic node (e.g., “kitchen”), ensuring that the relationship between objects and their environment is clearly defined. This structure enables efficient reasoning and traversal from abstract areas to specific object instances.

By incorporating semantic meaning and perception-based connectivity, the scene graph allows the robot to ground high-level semantic reasoning in its physical environment. It can disambiguate between similar object instances based on contextual cues (e.g., “the mug in the office” vs. “the mug in the kitchen”) and navigate accordingly. This architecture supports robust task execution in complex settings, such as homes, offices, or warehouses.

In such a manner, the scene graph 810 provides a structured, multi-resolution representation of the environment, enabling a robot to perform tasks involving object disambiguation and context-aware navigation. The construction of this graph is dynamic and grounded in the robot's sensor data and semantic understanding.

In one embodiment, the scene graph is initially constructed by detecting objects across a sequence of ego-centric RGB-D image frames captured as the robot performs a random walk through its environment. As the robot moves, its onboard sensors (e.g., RGB camera and depth sensor) collect data from its field of view. Detected objects in each frame are represented as individual nodes, and edges are formed between these nodes based on their spatial proximity, measured using a configurable distance threshold. For example, two objects detected in the same room that lie within a reachable range may be connected in the graph to indicate navigable adjacency.

As the robot continues to explore, multiple local scene graphs are generated at different time steps, each capturing the layout of objects within the robot's immediate perception. In some embodiments, the system constructs a global semantic scene graph by merging overlapping local graphs. The merging is performed based on a combination of factors, including spatial proximity of object centroids, object class similarity (e.g., multiple detections of the same type of object), and neighborhood similarity in 3D space. This integration process enables the robot to progressively build a consistent and comprehensive map of the environment, even in cluttered settings.

In some embodiments, higher levels of abstraction within the scene graph are created by clustering lower-level object nodes. This clustering is performed by a large language model (LLM) that is prompted to assign semantic labels to groups of nodes based on their object categories and 3D positions. As shown in FIG. 8, this hierarchical organization results in intermediate nodes that represent rooms, shared spaces, or functional zones, allowing the robot to understand and reason about the environment beyond individual objects.

To support flexible semantic reasoning, in some implementations the graph is constructed recursively. At each hierarchical level, a distinct prompt is provided to the LLM to define a different semantic grouping criterion. For example, a first prompt might cluster objects by room, while a subsequent prompt might group rooms into wings of a building. This recursive construction yields a multi-tiered graph that captures both the physical layout and the semantic structure of the environment.

Edges between nodes in the graph are created based on sensorial connectivity constraints, as previously described, and more specifically, based on a spatial distance metric. In some embodiments, the robot uses a threshold defined over Chamfer distance, or point cloud overlap between object centroids to determine whether a direct edge should exist between two nodes. This ensures that connections in the graph are not just semantically meaningful but also physically traversable by the robot.

In some embodiments, the semantic hierarchical scene graph is incrementally updated during runtime. As the robot explores new areas or encounters previously unseen objects, it adds new nodes and edges to the graph. The system uses similarity-based merging criteria to integrate new observations into the existing structure, preserving consistency and avoiding redundancy. This enables the robot to continuously refine its understanding of the environment as it gathers more data, enhancing both the accuracy of object disambiguation and the robustness of navigation.

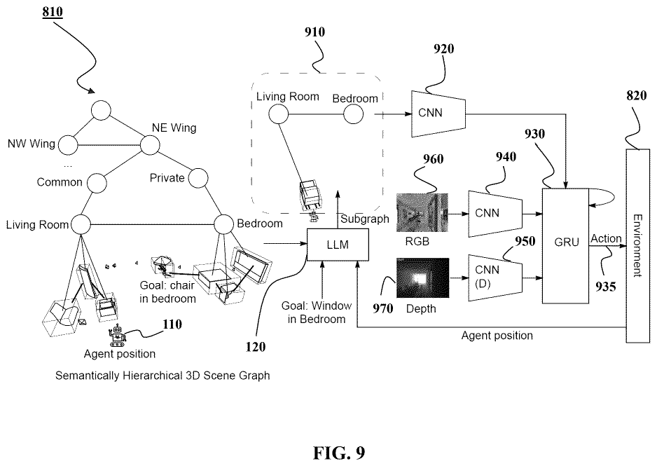

FIG. 9 illustrates a schematic overview of the navigation of a robot 110 as it performs tasks in a structured environment 820, using a semantic hierarchical scene graph 810 as a unified interface between perception and reasoning, in accordance with some embodiments. As previously described, the scene graph 810 provides a multilevel abstraction of the environment, encoding individual objects, functional areas, and global spatial semantics. This structured representation enables the robot to localize itself, reason about object context, and plan feasible actions by integrating both its local perceptual inputs and high-level semantic knowledge.

In some embodiments, the robot 110 includes one or more sensors for real-time sensorial perception of the environment. These may include RGB cameras providing visual measurements 960 and depth sensors providing depth data 970. The sensor inputs define the robot's field of view and allow the robot to update its internal state and localize its position with respect to the environment and task objectives.

To carry out a task—such as navigating to or retrieving an object based on a semantic instruction—the system utilizes a large language model (LLM 120) capable of reasoning over the hierarchical structure of the scene graph. The LLM receives the robot's current location (expressed as a node in the graph) and a natural-language prompt describing the goal (e.g., “go to the printer nearest office NE-5”). Based on this input, the LLM identifies and returns a subgraph 910 representing a semantically coherent and physically feasible path from the robot's current location toward the goal.

This subgraph is then passed to a navigation module, which interprets it and generates a control policy using a set of neural network components. The navigation module comprises several processing blocks, including neural networks 920, 940, and 950 for processing sensory and spatial features. A graph encoder 930 is configured to encode the subgraph 910 along with features extracted from the sensory inputs 960 and 970. The graph encoder employs a sequence of graph neural network layers, such as graph attention layers and edge convolution layers, to model structural and semantic relationships within the subgraph. These layers capture both geometric layout and functional relationships relevant to task execution.

Based on the encoded features, the navigation module generates a predicted action 935, which is issued to a motor controller. The motor controller converts the high-level command into low-level actuator signals, enabling the robot to perform physical movements such as navigating forward, turning, or stopping. The robot's inertial measurement unit (IMU) and additional onboard sensors are used to monitor orientation and validate the robot's actual position against the expected state as defined within the scene graph.

This process is iterative. As the robot moves and gathers new perceptual data, the system continuously updates its location within the scene graph, sends an updated query to the LLM, and receives a refined subgraph for the next navigation step. This enables the robot to handle occlusions, and interpret complex, context-rich instructions with semantic precision.

In this architecture, the semantic hierarchical scene graph 810 acts as a vital intermediary between the abstract reasoning capabilities of the LLM 120 and the grounded, real-world perception and actuation capabilities of the robot 110. The use of graph-based and image-based neural network modules ensures that the robot can generalize across diverse environments, adapt to novel tasks, and operate effectively in semantically rich and spatially complex domains.

### Examplar Implementations

### Problem Formulation and Overview

In some embodiments, the agent begins by performing a random walk of T steps in order to construct a scene graph that captures a substantial portion of the environment through which the agent is navigating. This exploration phase results in a sequence of temporally evolving local scene graphs, one for each video frame recorded during the agent's movement. The sequence is denoted by:

$$𝒢 = \{ {G}_{1} , {G}_{2} , ... , {G}_{T} \} ,$$

where each local graph at time step t is represented as:

$${G}_{t} = ( {V}_{t} , {E}_{t} , {F}_{t} )$$

### Here,

$${V}_{t} = \{ {v}_{1}^{t} , {v}_{2}^{t} , ... , {v}_{n}^{t} \}$$

denotes the set of detected object vertices at time t;

$${E}_{t} = \{ {e}_{uv}^{t} \vert ( u , v ) ∈ {V}_{t} \times {V}_{t} \}$$

represents the set of undirected edges based on spatial proximity; and

$${F}_{t} = {\{ ( {f}_{v}^{t} , {p}_{v}^{t} , {C}_{v}^{t} ) \}}_{v ∈ {V}_{t}}$$

denotes the set of attributes associated with each vertex, where

$${f}_{v}^{t}$$

is the neural feature vector,

$${p}_{v}^{t} ∈ {ℝ}^{3}$$

is the centroid of the 3D point cloud corresponding to the object represented by vertex v, and

$${C}_{v}^{t}$$

is the class label of that object.

For example, a vertex v may represent a chair detected in the scene, and an edge eᵤᵥ between a chair node u and a table node v would be formed if the spatial proximity condition is satisfied. The neural features fᵤ and fᵥ may correspond to pre-extracted visual features (e.g., Mask-RCNN features) of the chair and the table, respectively.

Subsequently, a hierarchical scene graph with H levels of abstraction is constructed from the aggregated graph sequence. This hierarchical organization is facilitated by a large language model (LLM), denoted [symbol] parameterized by θ, and provides increasing semantic abstraction at each level. This hierarchy may include object-level nodes, room-level nodes, and higher-order semantic zones.

Following the graph construction, the agent, e.g., robot, is repositioned to a start location Pₛₜₐᵣₜ, if such a location is specified in the navigation instruction. Otherwise, the agent's position at the end of the random walk is used as the start. The start location is localized in the scene graph by finding the vertex whose 3D centroid is closest to the agent's current physical location A_{loc}∈ [symbol] . This is formally defined as:

$${P}_{start} = arg {min}_{i ∈ \{ 1 , ... , T \}} {‖ {A}_{loc} - {p}_{i} ‖}_{2} , \qquad ( 1 )$$

where pᵢ denotes the centroid of object i in the 3D point cloud. The localized position is then set as A_{loc}=Pₛₜₐᵣₜ.

Each vertex v in the full hierarchical graph is assigned a binary visited attribute Wᵥ∈{0,1}, initialized as:

$${W}_{v} = 0 , ∀ v ∈ 𝒢 . \qquad ( 2 )$$

To initiate navigation, the full hierarchical graph, the agent's current location A_{loc}, and a natural language task prompt P are submitted to the LLM [symbol] The LLM predicts a 2-hop subgraph from the current location that lies along the inferred path toward the goal object or region. During task execution, if the agent visits a vertex and all of its descendant nodes in the graph hierarchy, the associated attribute is updated to Wᵥ=1.

The predicted subgraph, along with real-time perceptual input, is then processed by an action forecasting module [symbol] parameterized by φ. This module takes as input: the predicted subgraph, the RGB image of the agent's current view Iₜ∈ [symbol] , the ego-centric depth map Dₜ∈ [symbol] , and the previous action aₜ₋₁. The module outputs the next action aₜ∈ [symbol] , where the action space [symbol] includes: move forward, turn right, turn left, look up, look down, stop.

After executing the predicted action at, if the goal has not yet been reached, the process is repeated. In some embodiments, the task prompt P may be augmented with negative prompts to instruct the LLM to avoid revisiting certain subgraphs or areas already explored, thus enhancing efficiency and preventing redundant exploration.

### Semantically Hierarchical Scene Graphs

In some embodiments, the robot is equipped with an RGB camera and a depth camera, which together provide an ego-centric RGB-D view of the environment. The agent is also assumed to have access to its own position and pose information at all times. Let I denote the RGB image frame, and D denote the corresponding depth image. Let Π∈ [symbol] denote the camera pose matrix with respect to a global reference frame.

To construct a scene graph representing the environment for navigation, the agent undertakes a random walk of T steps. At each step, the agent selects one of six possible actions from the action space:

$$𝒜 = \{ moveforward , turnright , turnleft , lookup , lookdown , stop \} .$$

The action is sampled from a categorical distribution with uniform probability over six classes:

$$p ∼ Cat ( 6 ) , \qquad ( 3 )$$

$$a = {𝒜}_{p} , \qquad ( 4 )$$

where [symbol] denotes the p^{th} action in the set A.

At every step, object detection is performed using a pre-trained Mask-RCNN model. The model takes/as input and outputs a tuple (l, b, X, p, C, s), where: I is the object label, b is the bounding box, X is the feature vector of the object, p is the centroid of the corresponding 3D point cloud, C is the class label, s is the confidence score of the detection.

Only detections satisfying a confidence threshold s>η, for some 0<η≤1, are retained. The centroid p is computed from the subset of 3D points in the depth map D that lie within the bounding box b. Each such tuple becomes a node in the scene graph Gt constructed at time step t.

To construct edges between nodes in Gₜ, spatial proximity in 3D space is used. Let pᵤ and pᵥ denote the 3D positions of nodes u and v, respectively. An edge eᵤᵥ is formed if:

$$‖ {p}_{u} - {p}_{v} ‖ < ζ ,$$

for a chosen distance metric and threshold ζ>0. In some embodiments, this distance metric may be the Chamfer distance between the point clouds.

As the agent moves through space, there is a likelihood that frames (Iₜ₋₁, Dₜ₋₁) and (Iₜ, Dₜ) at time steps t−1 and t contain overlapping views of the same objects. Thus, the local scene graphs at each step can be registered and merged to form a more compact, unified 3D scene graph. Let Gₜ₋₁ be the scene graph accumulated up to time t−1, and let Gₜ be the scene graph at time t. Let Πₜ be the camera pose at time t. The position of each node pᵤ in Gₜ is transformed into a canonical global frame via:

$${p}_{{u}^{′}} = {\prod }_{t} {p}_{{u}^{′}}$$

where pᵤ is represented as a 4×1 homogeneous coordinate vector, and Πₜ is the 3×4 projection matrix.

To merge a node [symbol] from Gₜ with a node u^{g} from Gₜ₋₁, the following criteria must be satisfied:

$$Match ( {u}^{ℓ} , {u}^{g} ) = ( i ) ⋀ ( ii ) ⋀ ( iii ) , \qquad ( 5 )$$

where:

$$C ( {u}^{ℓ} ) = C ( {u}^{g} ) , \qquad ( 6 )$$

$$‖ p ( {u}^{ℓ} ) - p ( {u}^{g} ) ‖ \leq δ , \qquad ( 7 )$$

$$𝒩 ( {u}^{ℓ} ) ∼ 𝒩 ( {u}^{g} ) , \qquad ( 8 )$$

Here, [symbol] (u) denotes the set of neighbors of node u. Approximate neighborhood matching is defined as the presence of a non-empty intersection of neighbor pairs. That is, define:

$${S}_{{u}^{ℓ}} = \{ ( {u}^{ℓ} , v ) \vert v ∈ 𝒩 ( {u}^{ℓ} ) \} , {S}_{{u}^{g}} = \{ ( {u}^{g} , v ) \vert v ∈ 𝒩 ( {u}^{g} ) \} .$$

Then,

$$\vert {S}_{{u}^{ℓ}} ⋂ {S}_{{u}^{g}} \vert > η ,$$

for some threshold η>0.

When nodes [symbol] and u^{g} satisfy the merge criteria, their features are updated via a soft update rule:

$$X ( {u}^{g} ) ← λ X ( {u}^{g} ) + ( 1 - λ ) X ( {u}^{ℓ} ) ,$$

for a mixing coefficient λ∈(0,1). Additionally, the neighbor list of u^{g} is expanded to include all non-redundant neighbors of [symbol] that were not already part of Gₜ₋₁.

If [symbol] does not satisfy the criteria for merging, it is added to the scene graph as a new node, with edges created based on the same spatial proximity rules described above.

While this process constructs a structurally rich representation of the scene, it does not yet capture higher-level semantics. To incorporate such semantic structure, the resulting scene graph is transformed into a hierarchical representation, as described in the following section.

### Graph Clustering

In order to extract higher-level semantic representations, some embodiments perform semantic clustering of the graph using a large language model (LLM), denoted as [symbol] with parameters θ. The input to the LLM is a textual representation of the scene graph, which includes the list of nodes along with their class labels and 3D positions, and the set of edges. The LLM is prompted with a message P_{M} such as: “Please cluster the nodes in the graph into disjoint groups, where each group could be either: a kitchen, a living room, a restroom, a bedroom, or a balcony.”

The set of semantic clusters returned by the LLM is denoted as:

$$𝒞 = {\{ {C}_{v} \}}_{v ∈ 𝒢} , \qquad ( 10 )$$

$$𝒞 = {ℳ}_{θ} ( V , E , C , {P}_{M} ) , \qquad ( 11 )$$

where C denotes the class labels, and V, E are the vertices and edges of the original graph.

Each group in [symbol] is promoted to a new node in the graph, annotated with a semantic name and a representative location, calculated as the average 3D centroid of its constituent members. The new node is connected to all its group members via edges. Furthermore, using the spatial proximity criteria defined in Equation (5), edges may be formed between these semantic group nodes.

This clustering process may be applied recursively to form multiple abstraction levels. For example, in the next hierarchical level, group labels might include common and private; and at an even higher level, North-East, North-West, South-East, and South-West may be used. The formulation is general and allows for user-defined group names to capture arbitrary semantic structures.

### Subgraph Prediction

To enable goal-directed navigation, the system queries the LLM [symbol] with the full scene graph, the current position of the agent, and a prompt P describing the target object and its context. The LLM is asked to return the 2-hop subgraph from the agent's current location A_{loc} that lies along the path to the target.

The prompt may be of the form:

$$P = {}^{‶} Find the < objectname > , < context {>}^{″} ,$$

where the <object name> is the class (e.g., pillow, mug, laptop), and the <context> is a spatial or functional constraint (e.g., “on the bed in the bedroom in the northeast wing”). When no disambiguation is needed, the context may be omitted.

Starting with P′: =P, the prompt is augmented to specify a 2-hop neighborhood prediction:

$${P}^{′} := {}^{‶} Predict the 2 - hop neighbor of {A}_{loc} in order {to}^{″} ⋃ {P}^{′} . \qquad ( 12 )$$

To prevent the LLM from generating paths that traverse irrelevant or completed subgraphs, the prompt is further refined using visited status Wᵥ_{^{l}} for nodes at hierarchical levels l>1. Let v^{l} be a node at level l, and pp(v^{l-1}) denote its parent's parent. The prompt is updated as:

$$𝒞 := {⋃}_{l = 2}^{H - 1} {}^{‶} < {C}_{pp ( {v}^{l - 1} )} > {in}^{″} , where {W}_{{v}^{2}} = 1 , {v}^{2} = {A}_{loc} , \qquad ( 13 )$$

$$𝒞 := 𝒞 ⋃ < {C}_{H} > , \qquad ( 14 )$$

$${P}^{′} := {P}^{′} ⋃ {}^{‶} which does not contain a < 𝒞 {>}^{″} , \qquad ( 15 )$$

where Cᵥ_{^{l}} is the class label of node v^{l}, C_{H} is the root node label, and U denotes prompt augmentation. The final prompt P′ is submitted to the LLM to obtain the 2-hop subgraph output, denoted [symbol] .

### Action Forecasting Model

Given the 2-hop subgraph [symbol] generated by the LLM [symbol] , an action forecasting model f_{φ}, parameterized by φ, is used to predict the next action aₜ at time t. The model is composed of a graph convolutional network (GCN), followed by a pooling layer such as graph attention average pooling (GAP). The feature encoding is represented as:

$${G}_{t} = G A P ( G C N ( {𝒢}_{t} ) ) . \qquad ( 16 )$$

The GCN may include several layers, such as node convolution layers, edge convolution layers, and attention mechanisms.

Additionally, the RGB image Iₜ and depth map Dₜ from the agent's current view are processed through a convolutional encoder, such as a ResNet-based backbone, to extract visual features. These features are fused with the graph encoding and fed into a recurrent neural network (e.g., GRU or LSTM) to predict the next action:

$${a}_{t} = {f}_{ϕ} ( {G}_{t} , {I}_{t} , {D}_{t} ) , {a}_{t} ∈ \qquad ( 17 )$$

$$\{ move forward , turn right , turn left , lookup , lookdown , stop \} .$$

### Training

In some embodiments, only the subgraph encoder module of the architecture is trained. Training data is collected in the form of embodied navigation trajectories, generated by human experts navigating the agent to goal locations over multiple episodes. Let N denote the number of episodes, and let Lᵢ be the number of steps in episode i. The training objective is to minimize the cross-entropy loss between the predicted and ground-truth actions:

$$min \frac{1}{N} {\sum }_{i = 1}^{N} \frac{1}{{L}_{i}} {\sum }_{j = 1}^{{L}_{i}} C E ( {\tilde{a}}_{i}^{j} , {a}_{i}^{j} ) , \qquad ( 18 )$$

where

$${\tilde{a}}_{i}^{j}$$

is the ground-truth action (from expert annotation),

$${a}_{i}^{j}$$

is the model's prediction, and CE(⋅,⋅) denotes the standard cross-entropy loss function.

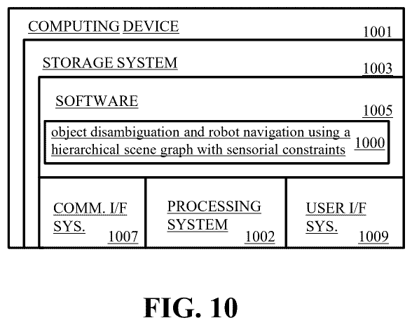

FIG. 10 shows a schematic of computing device 1001 that is representative of any system or collection of systems in which the various processes, programs, services, and scenarios of some embodiments disclosed herein are implemented. Examples of computing device 1001 include, but are not limited to, desktop and laptop computers, tablet computers, mobile computers, server computers, web servers, cloud computing platforms, and data center equipment, as well as any other type of physical or virtual server machine, container, and any variation or combination thereof.

Computing device 1001 may be implemented as a single apparatus, system, or device or may be implemented in a distributed manner as multiple apparatuses, systems, or devices. Computing device 1001 includes, but is not limited to, processing system 1002, storage system 1003, software 1005, communication interface system 1007, and user interface system 1009. Processing system 1002 is operatively coupled with storage system 1003, communication interface system 1007, and user interface system 1009.

Processing system 1002 loads and executes software 1005 from storage system 1003. Software 1005 includes and implements principles of object disambiguation and robot navigation using a hierarchical scene graph with sensorial constraints 1000 described in various exemplar embodiments throughout this disclosure. When executed by processing system 1002, software 1005 directs processing system 1002 to operate as described herein for at least the various processes, operational scenarios, and sequences discussed in the foregoing implementations. Computing device 1001 may optionally include additional devices, features, or functionality not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, digital signal processors, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory, and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 may be implemented in program instructions and among other functions may, when executed by processing system 1002, direct processing system 1002 to operate as described with respect to the various operational scenarios, sequences, frameworks, and processes illustrated and/or discussed herein. For example, software 1005 may include program instructions for implementing the sampling, training, and/or rendering processes described herein, as well as the probabilistic guided sampling discussed herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software.

Software 1005 may also comprise firmware or some other form of machine-readable processing instructions executable by processing system 1002.

In general, software 1005 may, when loaded into processing system 1002 and executed, transform a suitable apparatus, system, or device (of which computing device 1001 is representative) overall from a general-purpose computing system into a special-purpose computing system customized to perform computer vision processes in an optimized manner. Indeed, encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 1001 and other computing systems, may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the appended claims to cover all such variations and modifications as come within the true spirit and scope of the present disclosure.

1. A robot for performing a task on objects in an environment, comprising:
one or more sensors configured to provide a sensorial perception of the environment corresponding to current position of the robot;
a motor configured to navigate the robot in response to control commands;
a memory configured to store a semantically hierarchical scene graph representing the environment, the scene graph comprising a connected graph of nodes organized into a multilevel hierarchy, including nodes associated with objects in the environment, wherein edges between nodes are subject to sensorial connectivity constraints, such that an edge connects a first node to a second node only if the sensorial perception of the robot enables navigation from a location associated with the first node to a location associated with the second node without passing through a location associated with a third node; and
a processor configured to iteratively
identify a subgraph of the semantic hierarchical scene graph associated with the task within the semantic hierarchical scene graph using a large language model (LLM) trained with machine learning to exhibit reasoning abilities as applied to the task and the current position of the robot; and
generate a control command for the motor of the robot based on the task and the portion of the semantic hierarchical scene graph.

2. The robot of claim 1, wherein the semantic hierarchical scene graph comprises:
a root node representing a global region of the environment;
a plurality of intermediate semantic nodes representing functional areas of the environment; and
a plurality of leaf nodes representing individual objects detected within those functional areas.

3. The robot of claim 1, wherein each node of the semantic hierarchical scene graph is associated with one or more attributes selected from: a semantic label, a spatial location, a hierarchical level, and a set of neighboring nodes connected by edges satisfying the sensorial connectivity constraints.

4. The robot of claim 1, wherein the semantic hierarchical scene graph comprises a tree-like structure in which each non-root node has exactly one parent node corresponding to a higher-level semantic region, and wherein object nodes are children of semantic nodes representing the spatial or functional context of those objects.

5. The robot of claim 1, wherein the semantic hierarchical scene graph is constructed by detecting objects in a sequence of ego-centric RGB-D image frames captured during a random walk of the robot, wherein each detected object forms a node and edges are created between spatially proximate nodes based on a distance threshold.

6. The robot of claim 1, wherein the semantic hierarchical scene graph is constructed by merging overlapping local scene graphs generated from different time steps, based on spatial proximity, object class similarity, and approximate neighborhood similarity in 3D space.

7. The robot of claim 1, wherein higher levels of the semantic hierarchical scene graph are formed by clustering nodes from lower levels using the LLM configured to assign semantic labels to groups of nodes based on their object classes and 3D locations, thereby generating abstract representations including one or a combination of rooms, shared spaces, and functional zones.

8. The robot of claim 1, wherein the semantic hierarchical scene graph is constructed recursively, such that each level of the hierarchy is generated by applying a different prompt to the LLM, with each prompt defining a distinct semantic grouping criterion.

9. The robot of claim 1, wherein edges in the semantic hierarchical scene graph are created between two nodes if the spatial distance between the associated object centroids is below a predefined threshold, the distance being computed using a metric selected from Chamfer distance, or point cloud overlap.

10. The robot of claim 1, wherein the semantic hierarchical scene graph is incrementally updated during robot operation by adding new nodes and edges based on newly detected objects and integrating them into the existing graph structure using similarity-based merging criteria.

11. The robot of claim 1, wherein the processor is further configured to:
submit the current position of the robot and a prompt defining the task to the LLM;
receive from the LLM a subgraph extracted from the semantic hierarchical scene graph, the subgraph representing a navigable path toward the object of interest; and
use the subgraph in combination with sensory perception data from the robot to generate a control command via a navigation module comprising a graph neural network (GNN) and a recurrent neural network (RNN).

12. The robot of claim 11, wherein the subgraph produced by the LLM comprises a two-hop neighborhood in the semantic hierarchical scene graph from the node corresponding to the current location of the robot.

13. The robot of claim 11, wherein the navigation module processes both the LLM-predicted subgraph and real-time visual inputs from the sensors of the robot, including RGB and depth images, to predict next movement action using a multi-layer neural network comprising graph convolution layers, image encoders, and a gated recurrent unit (GRU).

14. The robot of claim 11, wherein the navigation module comprises:
a graph encoder configured to encode the subgraph received from the LLM using a sequence of graph convolutional layers including graph attention and edge convolution layers;
an image encoder configured to extract features from images captured by the sensors of the robot; and
a recurrent neural network comprising a gated recurrent unit (GRU) configured to receive the encoded subgraph and image features and generate a control command representing a next action of the robot.

15. The robot of claim 14, wherein the navigation module is trained using supervised learning on a dataset of expert navigation trajectories, the training comprising minimizing a loss function between predicted actions and ground-truth actions taken by a human operator during navigation tasks involving semantic disambiguation of object instances.

16. The robot of claim 15, wherein the actions predicted by the navigation module include one or more of: moving forward, turning left, turning right, looking up, looking down, and stopping.

17. The robot of claim 1, wherein the task is performed in cooperation with a second robot having a different set of sensors and a distinct semantic hierarchical scene graph representing the same environment.

18. The robot of claim 17, wherein the processor is further configured to:
receive action-related context or subgraph updates from the second robot;
reconcile differences between the distinct semantic hierarchical scene graphs; and
adjust its predicted actions based on the second robot's complementary perception and subgraph information.

19. The robot of claim 1, wherein the task comprises locating and navigating to a specific instance of an object class based on a semantic instruction that includes spatial or functional context.

20. A method for performing a task on objects in an environment by a robot, wherein the method uses a processor coupled with stored instructions implementing the method, wherein the instructions, when executed by the processor carry out steps of the method, comprising:
receiving a semantic instruction that includes spatial or functional context of the task;
receiving, via one or more sensors, a sensorial perception of the environment corresponding to a current position of the robot;
accessing a memory storing a semantic hierarchical scene graph representing the environment, the scene graph comprising a connected graph of nodes organized into a multilevel hierarchy including nodes associated with objects in the environment, wherein edges between nodes are subject to sensorial connectivity constraints such that an edge connects a first node to a second node only if the sensorial perception of the robot enables navigation from a location associated with the first node to a location associated with the second node without passing through a location associated with a third node;
identifying a subgraph of the semantic hierarchical scene graph associated with the task by using a large language model (LLM) trained with machine learning to exhibit reasoning abilities, the identification being based on the task and the current position of the robot within the scene graph; and
generating a control command based on the identified subgraph and the task, and providing the control command to a motor to navigate the robot within the environment.
